(19) United States
(12) Patent Application Publication
(10) Pub. No.: US 2026/0049877 A1
(43) Pub. Date: Feb. 19, 2026

(54) DEVICE FOR PRECISE INSTALLATION OF SENSORS

(71) Applicant: Google LLC, Mountain View, CA (US)

(72) Inventors: Guillermo Fabian Díaz Lankenau, Santa Cruz, CA (US); Antonio Yamil Layon Halun, Mountain View, CA (US)

(21) Appl. No.: 18/802,807

(22) Filed: Aug. 13, 2024

(51) Int. Cl. G01L 1/22; G01L 1/20

(52) U.S. Cl. CPC G01L 1/2206; G01L 1/205

(57) ABSTRACT

Systems and devices are disclosed for improving image quality in a video communication system. The video communication system can be a 3D teleconferencing system that includes a large format display. Improvements can be realized through the use of a jig that provides for precise installation of sensors onto surfaces of a flexure device that mounts to the back side of the display. The sensors can include structural sensors such as strain gauges that can provide feedback regarding distortion of the display that can disturb camera locations. The devices, systems, and methods described may apply generally to the installation of sensors in high volume manufacturing.

### FIELD OF THE DISCLOSURE

The present disclosure relates to a device and method of installation for sensors and, in particular, for installation of strain gauges in a video conferencing system.

### BACKGROUND

Video communication systems, e.g., systems used for three-dimensional (3D) video conferencing or video chats, facilitate collaboration in real space. Augmented reality (AR) or virtual reality (VR) systems can deliver a more comprehensive user experience, but they require users to wear headsets that transition the user from their natural environment into an immersive virtual space. Superior image quality can be achieved in a 3D video conferencing system through precise positioning of equipment mounted to a large format display.

### SUMMARY

The present disclosure describes devices, systems, and methods for improving image quality in a 3D video communication system, through the use of a device for precise installation of sensors, e.g., strain gauges, onto a large format display.

In some aspects, the techniques described herein relate to a device, including: a fixture; a shelf configured for fixed attachment to the fixture, the shelf equipped with alignment structures; a film configured to couple to the alignment structures; and a workpiece configured for attachment to the fixture and translational motion in a single direction.

In some aspects, the techniques described herein relate to a system, including: a micro-sensor; a workpiece configured to receive the micro-sensor; and a fixture configured to hold the micro-sensor and the workpiece while guiding alignment of the micro-sensor to the workpiece.

In some aspects, the techniques described herein relate to a method, including: forming slotted guides and holes in a fixture; attaching the fixture to a support structure; attaching gauges to a transfer tape; adhering the transfer tape to a shelf equipped with alignment structures; attaching the shelf to the fixture through the holes; attaching a workpiece to the fixture through the slotted guides; and lowering the workpiece onto the shelf.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a pictorial view of a 3D video communication system according to a possible implementation of the present disclosure.

FIG. 2 is a perspective view of a front side of a 3D light field display according to a possible implementation of the present disclosure.

FIG. 3A is an exterior perspective view of a flexure device, according to a possible implementation of the present disclosure.

FIG. 3B is an interior perspective view of a flexure device, according to a possible implementation of the present disclosure.

FIG. 4A is a magnified top perspective view of sensors attached to a crossbar of the flexure device, according to a possible implementation of the present disclosure.

FIG. 4B is a magnified top perspective view of a sensor on a crossbar of the flexure device, according to a possible implementation of the present disclosure.

FIG. 5 is an exploded view of a system for accurate sensor placement, according to a possible implementation of the present disclosure.

FIG. 6 is a magnified exploded view of a shelf assembly, according to a possible implementation of the present disclosure.

FIG. 7 is a magnified side view of a tapered alignment pin, according to a possible implementation of the present disclosure.

FIG. 8A is a front perspective view of the flexure device mounted to a low friction surface of the fixture, according to a possible implementation of the present disclosure.

FIG. 8B illustrates a pair of pivoting shelf assemblies according to a possible implementation of the present disclosure.

FIG. 9 is a flow diagram illustrating a method for precise installation of sensors, according to a possible implementation of the present disclosure.

FIG. 10 is a back perspective view of a fixture and a flexure, according to a possible implementation of the present disclosure.

FIG. 11 is a side elevation view of a system for precision installation of sensors, according to a possible implementation of the present disclosure.

FIGS. 12A and 12B illustrate attachment of sensors to a transfer tape, according to a possible implementation of the present disclosure.

FIG. 13 is a front perspective view of shelf assemblies mounted on a fixture, according to a possible implementation of the present disclosure.

FIG. 14 illustrates attachment of a flexure to the fixture shown in FIG. 13, according to a possible implementation of the present disclosure.

FIG. 15 is a side elevation view illustrating operation of a press, according to a possible implementation of the present disclosure.

FIG. 16A is a side elevation view of a workpiece prior to placing sensors, with the press in an up position according to a possible implementation of the present disclosure.

FIG. 16B is a side elevation view of a workpiece following placement of sensors, with the press in a down position, according to a possible implementation of the present disclosure.

Components in the drawings are not necessarily to scale relative to each other. Like reference numerals designate corresponding parts throughout the several views.

### DETAILED DESCRIPTION

An enhanced video communication system is possible in which a user's image is presented as a 3D model, without a need to wear an AR/VR headset. In the enhanced video communication system, for example, each user sits in a booth facing a light field display that includes a projection system and an array of cameras and lights directed at different angles. The light field display projects a 3D, hologram-like, life-size image of the user, for viewing by other, remote users. With such an arrangement, the video communication experience feels more realistic because the 3D imaging provides live volumetric capture that transmits body language and subtle facial expressions, not just a flat image of a “talking head.” Consequently, remote users can feel as though they are in the same room together.

3D lightfield displays can produce an autostereoscopic effect that enables an observer to perceive image depth (3D) without wearing special headgear. A stereoscopic effect can be created by a projection system that positions copies of an image in front of a user's left eye and right eye that are shifted horizontally relative to each other. An example 3D lightfield display uses lenticular optics to provide the autostereoscopic effect. The lenticular optics may be implemented as a series of vertically-oriented cylindrical camera lenses formed on a sheet, e.g., a lenticular film, that is fitted onto a display screen, to form an integrated 3D camera system. In some implementations, the lenses are formed as a 2D matrix covering the area of the display screen. In some implementations, the lenses are formed around an outer bezel of the display screen. In either arrangement, to precisely record and reproduce three-dimensional video, it is important that the shape of the display and the position of the camera array are known with high precision, and can be maintained for the entirety of the video session.

At least one technical problem with such 3D light field displays that combine multiple video feeds into a composite 3D image is that the video quality is diminished if the position of any one of the cameras varies. Slight changes in camera position can result from geometric distortion of the lenticular film, resulting in flickering or jumping, or blurred features in the composite image. Such a geometric distortion can be thermally induced. That is, localized heating of the display can occur due to the operation of light emitting diodes (LEDs) and/or other electronic components, or even by sunlight incident on the display. LEDs can raise the temperature of the backplate of a display in the vicinity of the LED, from room temperature (e.g., about 25 degrees C.) to about 75 degrees C. Such heating causes structural components of the display to expand, Often, the expansion is uneven, which can cause warping as well.

Consequently, existing commercial displays, used as computer monitors or televisions, lack the precision and the thermally stable geometry needed to sustain performance of the lenticular film, for high quality 3D video communication. Such displays are therefore not viable for hyper-realistic telepresence systems. For a camera projected at a distance of 1.2 m from a subject, camera motion is desirably less than about 200 μm, or the size of one display pixel. Currently available displays can experience about 0.1 mm to about 1.0 mm of relative motion between fixed points on the display.

Thermally induced camera motion can be compensated for by adding compliant mounts, e.g., flexures, to the backplate of the display, to allow for thermal expansion. The use of compliant mounts is discussed further in U.S. patent application Ser. No. 18/647,729. The compliant mounts, or flexures, can absorb strain to reduce distortion of the optical display. In some implementations, the flexures can be equipped with sensors to monitor strain, e.g., micro-sensors such as micro-mechanical strain gauges or micro-electromechanical (MEMS) strain gauges. Proper placement of the strain gauges on the flexures with accuracy to within about +/−0.2 mm is desirable for optimal effectiveness.

The disclosed systems and methods provide a technical solution to achieve accuracy and repeatability of sensor placement on the flexures with minimal human intervention. Use of the disclosed systems and methods can accelerate the pace of sensor installation, as needed for high volume manufacturability of a 3D light field display. A customized jig in the form of a rigid back plate, or fixture, can be used to attach sensors to the flexure in a controlled manner. Sensors can initially be attached to shelves that are mounted to the fixture in a stationary position, while the flexure is slidably mounted to the fixture. Then a clamp can be used to apply pressure to join the sensors with the flexure. Such a procedure can be used to mount other types of sensors, e.g., micro-sensors, to a generalized workpiece for use in contexts other than the present 3D display.

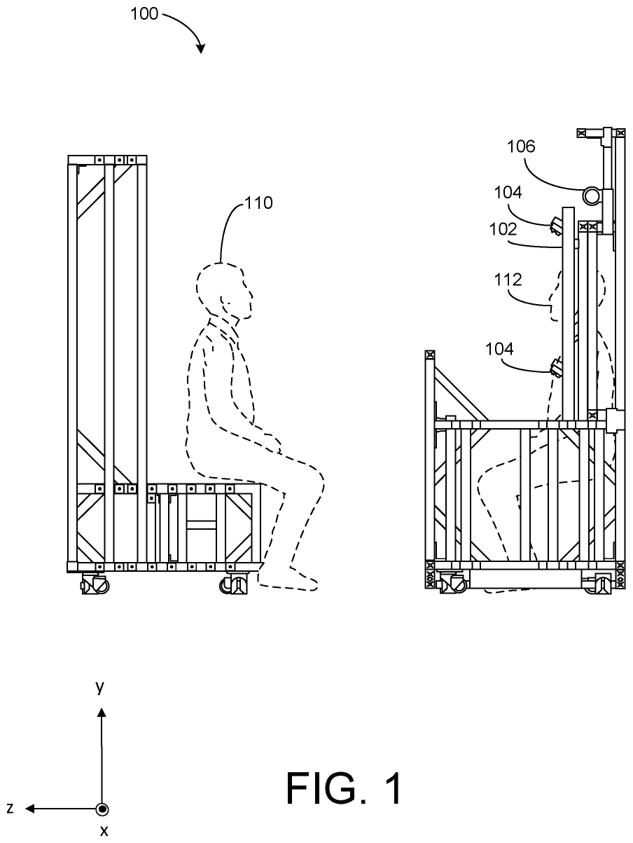

FIG. 1 shows a 3D video communication system 100 according to a possible implementation of the present disclosure. The 3D video communication system 100 includes a display 102, e.g., an optical display, onto which an array of display cameras 104 (two shown) are mounted in a precise arrangement. In some implementations, lenses of the display cameras 104 can be formed on a lenticular film attached to the display 102. Stress can alter positions of the display cameras 104 attached to the central area of the display 102 or to the perimeter of the display 102. Additionally, or alternatively, a frame camera 106 and/or light can be mounted on a separate frame above, below, or adjacent to the display 102.

A local user 110 can be seated opposite the display 102, to observe a 3D image 112 of a remote user. The local user 110 can be seated a few feet from the display 102, at a distance that would normally separate two people meeting together in the same room. The multiple display cameras 104 and the frame camera(s) 106 are focused simultaneously on the local user 110 to provide the remote user with a similar 3D image of the local user 110.

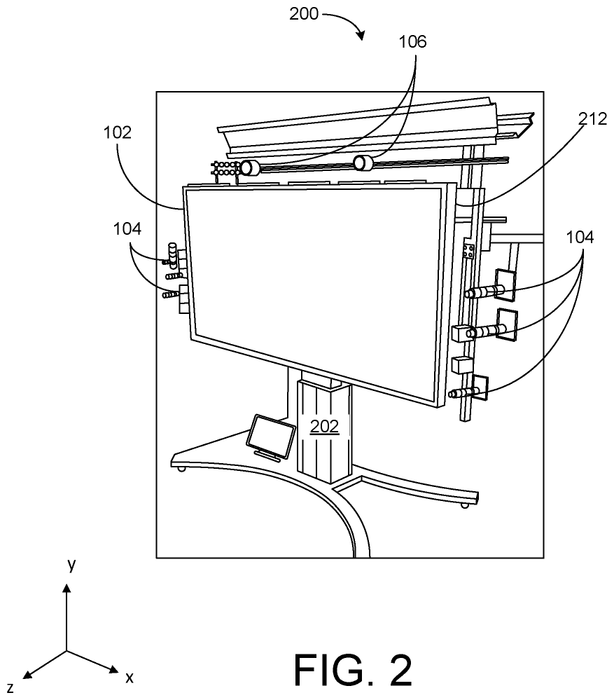

FIG. 2 shows a front view 200 of an example of the display 102, according to a possible implementation of the present disclosure. In FIG. 2, display cameras 104 (5 shown) are arranged around a perimeter, e.g., on a bezel, of the display 102. The display 102 can be supported by a frame 202. In some implementations, frame cameras 106 (2 shown) can be mounted to the frame 202, above, below, or to the sides of the display 102. A backplate 212 covers a back side of the display 102.

One of the challenges of the 3D video communication system 100 is to maintain accurate camera positions to successfully combine the video feeds from the various cameras. If the camera positions vary with respect to one another, the video image quality is diminished as the overlay of the video images becomes mis-aligned. While the display cameras 104 are subject to variations in their positions, even if the frame cameras 106 remain stationary, the relative positions of the various cameras may still vary. In some implementations, a choice of materials used in the display 102 or in the frame 202 can minimize distortion, for example, by substituting carbon fiber for aluminum. However, such materials may be cost-prohibitive.

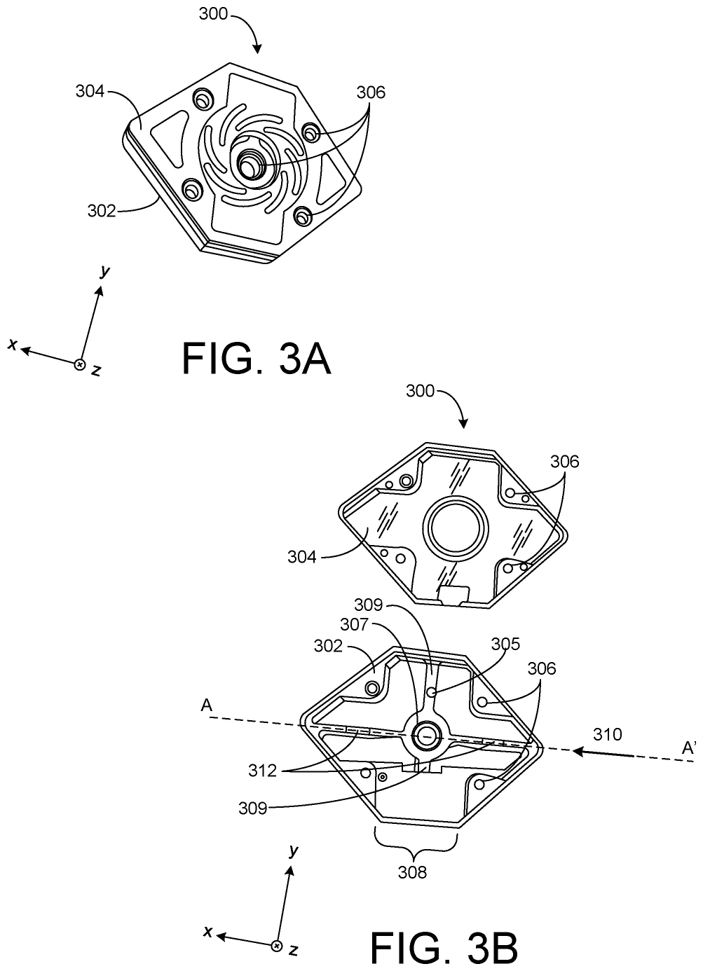

FIGS. 3A and 3B show different views of a compliant mount, or flexure 300, according to a possible implementation of the present disclosure. The flexure 300 can be mounted to the backplate 212 of the display 102 to reduce distortion thereof, so as to preserve positions of the display cameras 104.

FIG. 3A shows a perspective view of the exterior of the flexure 300. Exterior parts of the flexure 300 include a flexure body 302, a cover 304, and mounting holes 306 (5 shown, including a central mounting hole and 4 additional mounting holes). Although the shape of the flexure 300 is shown as hexagonal, the flexure 300 can have any other shape, e.g., square, rectangular, circular, octagonal, and so on. The flexure body 302 can include one or more metals or metal alloys, e.g., steel, titanium, aluminum, and the like. The cover 304 can be attached to the flexure 300 using fasteners, e.g., screws, bolts, nails, etc. that pass through the mounting holes 306. In some implementations, the approximate size of the flexure 300 is 100 mm wide, 75 mm tall, and 15 mm thick.

FIG. 3B shows an interior view of the flexure 300. In some implementations, interior parts of the flexure 300 can include mounting pins 305 (one of two shown), a spindle 307, on-board circuity 308, vertical members 309 (two shown), a crossbar 310, and sensors 312. The cover 304 serves to protect the on-board circuity 308 and the sensors 312.

In some implementations, the mounting pins 305 can be fixed along the vertical members 309. The flexure 300 can be mounted to the backplate 212 of the display 102 using the mounting pins 305.

In some implementations, the crossbar 310 can be aligned along a horizontal axis A-A′ of the flexure 300, and the sensors 312 can be disposed on, or placed on, the crossbar 310.

In some implementations, the sensors 312 can include, for example, strain gauges that can sense strain in the backplate 212 of the display 102. The sensors 312 can be elements of a feedback control system used to adjust locations and orientations of the cameras 104, 106 when rendering multiple camera perspectives into a three-dimensional video. With feedback control, when the sensors 312 detect strain, a previously calibrated model of the 3D video communication system 100 can convert the sensor signal 312 to updated camera positions, for use by internal software configured to carry out image superposition. In some implementations, the spindle 305 can include a ratcheting mechanism.

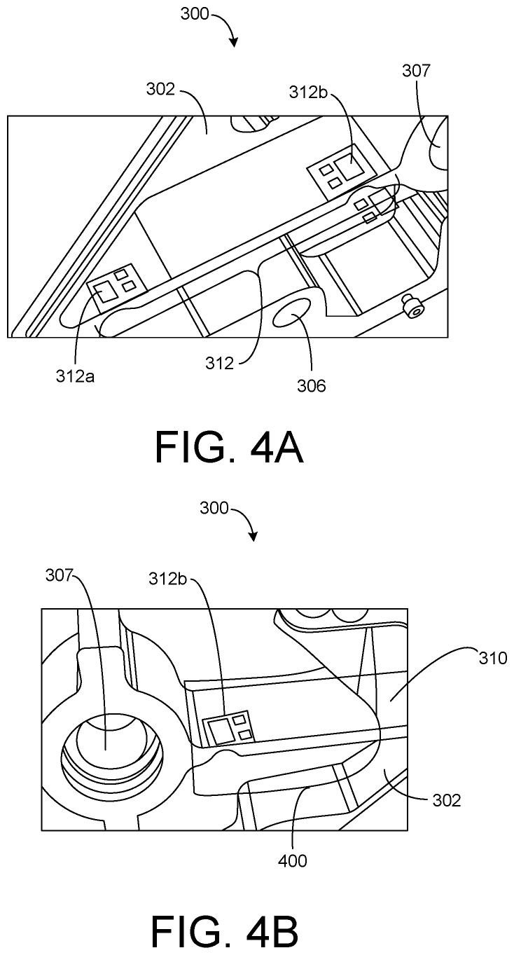

FIGS. 4A and 4B are magnified views of a central portion of the flexure 300, showing the crossbar 310, according to a possible implementation of the present disclosure. FIGS. 4A and 4B illustrate placement of the sensors 312 on a side of the crossbar 310 opposite the on-board circuity 308.

FIG. 4A is a magnified top perspective view of the crossbar 310 on which sensors 312 have been placed. In some implementations, a first sensor 312a can be placed close to an outer end of the crossbar 310; a second sensor 312b can be placed close to an inner end of the crossbar 310 near the spindle 305, at the center of the flexure 300. In some implementations, the sensors 312a and 312b can be placed flush with an edge of the crossbar 310. In some implementations, dimensions of the sensors 312a and 312b can range from about 1 mm to about 10 mm. Placement of the sensors 312 at precise locations on the crossbar 310 will yield the best strain reduction results, and consequently, the best quality camera images. In some implementations, any number of sensors 312 can be mounted on the flexure 300.

FIG. 4B is a magnified top perspective view that illustrates the flexure 300 during placement of the sensor 312b. As shown in FIG. 4B, the second sensor 312b is attached to a film 400, e.g., a plastic tape, or transfer tape that serves as a vehicle for the sensors 312. In some implementations, the sensors 312 can adhere to the film 400 using electrostatic forces. In some implementations, the sensors 312 can adhere to the film 400 using an adhesive. The film 400 can be used to position the sensors 312 relative to the crossbar 310. Once the sensors 312 are in place, the film 400 can be peeled off and discarded. To facilitate placement, the film 400 can have the form of a transparent, or translucent, plastic tape.

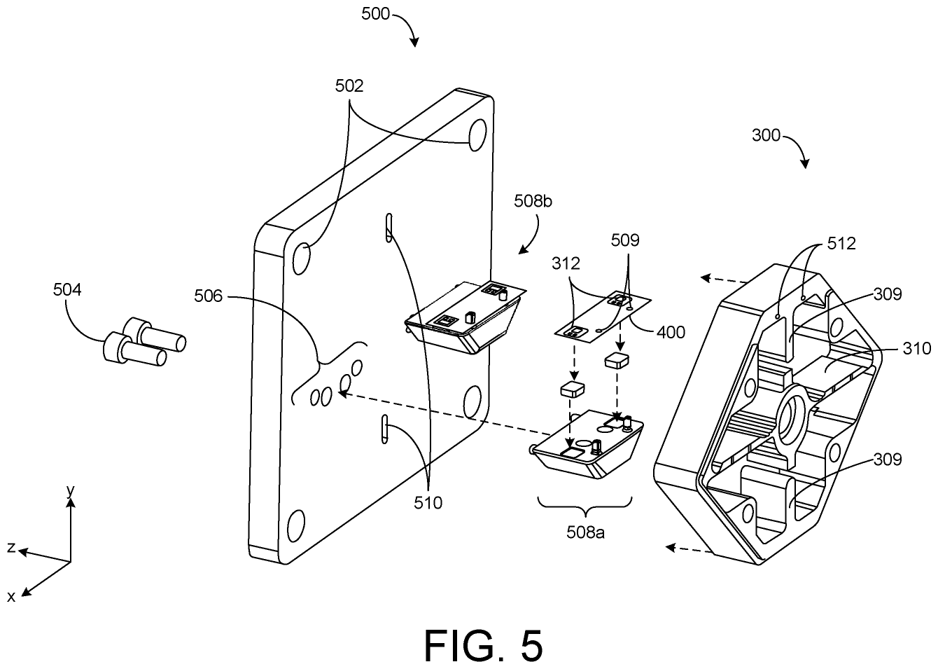

FIG. 5 illustrates a fixture 500 that can be used to attach the sensors 312 to the flexure 300, according to a possible implementation of the present disclosure. The fixture 500 can be used during an assembly process as a jig to hold each of the sensors 312 in a fixed position and to guide motion of the flexure 300 as the sensors 312 and the flexure 300 are joined together.

In some implementations, the fixture 500 can be in the form of a rigid plate, e.g., a thick metal plate, in which various openings, e.g., holes and slotted guides (slots) can be machined. For example, a first set of holes, e.g., corner holes 502, can be drilled in the fixture 500 for attaching the fixture 500 to a support structure (not shown) such as a wall or a freestanding holder. The fixture 500 can be attached to the support structure through the corner holes 502 using fasteners 504, e.g., screws, bolts, nails, etc.

A second set of holes 506 can be formed in the fixture 500 to receive fasteners of the shelf assemblies 508 (2 shown, 508a and 508b). Each shelf assembly 508 may be attached to the fixture 500, to support a film 400. The film 400 can carry one or more sensors 312 (two shown). The film 400 includes mounting holes 509 for mounting the film 400 onto the shelf assembly 508a.

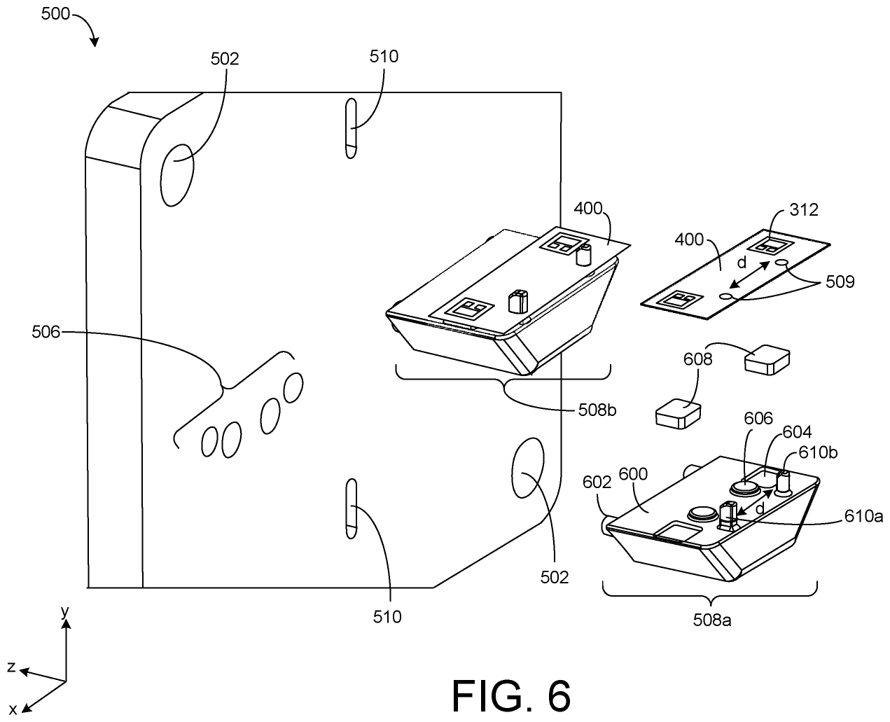

In the example of FIG. 5, the shelf assembly 508a is shown as an exploded view prior to mounting onto the fixture 500 through the second set of holes 506. The shelf assembly 508b is shown as fully assembled and mounted in place on the fixture 500 through another one of the second set of holes 506, located behind the shelf assembly 508b. The shelf assemblies 508 include features that are designed to hold in place the film 400, bearing the sensors 312. Such features of the shelf assembly 508 are described in detail below with reference to FIG. 6.

A third set of holes, e.g., slotted guides, or slots 510, can be formed in the fixture 500 to receive fasteners of the flexure 300, e.g., the mounting pins 305, and to adjust the position of the flexure 300 relative to the shelf assemblies 508a and 508b. In some implementations, the slots 510 can be elongated so as to permit translational motion of the flexure 300 in a single direction. In some implementations, the slots 510 are oriented along the y-direction (vertically) to align with the vertical members 309, so that the flexure 300 can be raised and lowered with respect to the sensors 312 on the shelf assemblies 508. Upper and lower slots 510 can be keyed to prevent upside down installation of the flexure 300. For example, a dimension, e.g., a diameter or a width, of the upper slot 510 can be different from that of the lower slot 510.

A set of holes, e.g., bolt holes 512 in the flexure 300, can be sized to accept small bolts in a range of about 1.4 mm to 1.8 mm in diameter.

FIG. 6 shows a magnified view of the shelf assembly 508a, prior to placement on the fixture 500 and the shelf assembly 508b, after placement on the fixture 500, according to a possible implementation of the present disclosure. In some implementations, each shelf assembly 508 can include a shelf 600, and features such as mounting pins 602, cavities 604, hard stops 606, alignment structures such as compliant elements 608 and alignment pins 610 (two shown, 610a and 610b), and round openings, e.g., the mounting holes 509, formed in the film 400. Such features can be helpful in achieving precise placement of the sensors 312 on the flexure 300. In some implementations, the shelf assembly 508 can further include a heating element that can be used to cure a heat-sensitive adhesive applied to the sensors 312.

In some implementations, a front end of the mounting pin 602 can be threaded and screwed into threaded holes in a back surface of the shelf 600. The shelf 600 will then remain in a stationary position upon insertion of a back end of the mounting pin 602 into the fixture 500 through an outer hole of the second set of holes 506.

In some implementations, the film 400 can be pre-formed with the mounting holes 509 spaced apart at a distance d that matches a separation distance between the alignment pins 610. When the film 400 is then lowered onto the alignment pins 610, each one of the sensors 312 will be positioned directly over a compliant element 608.

In some implementations, the alignment pins 610 are vertical pins that can be keyed so that only one mounting position is possible for the film 400. For example, the two alignment pins 610a and 610b and the two mounting holes 509 can have different diameters to prevent reverse installation of the film 400. In some implementations, one of the alignment pins, e.g., 61a0 can be radially truncated, e.g., flat on two opposing sides, to distinguish it from the other alignment pin 610b while still allowing both of the mounting holes 509 in the film 400 to be round., which reduces manufacturing costs. In some implementations, the flat sides of the radially truncated alignment pin 610a can be orthogonal to an axis connecting centers of the two round alignment holes 509 of the film 400. As a result, a location of the film 400 is controlled by the round alignment pin 610b, and rotation of the film 400 is controlled by the radially truncated alignment pin 600a.

In some implementations, each one of the compliant elements 608 can be placed in one of the cavities 604 prior to mounting the film 400 on the shelf 600. The compliant element 608 can include a compressible material, for example, a foam block or a rubber block. The compliant element 608 can be of a size and shape that substantially matches the sensor 312, e.g., that is approximately the same as, or slightly larger than a footprint of the sensor 312. As described in more detail below, the compliant element 608 and the hard stop 606 cooperate to control a maximum compression travel of the compliant element 608, and to distribute an associated pressure applied to the sensors 312. That is, the compliant element 608 and the hard stop 606 together can act as a protection mechanism for the sensor 312.

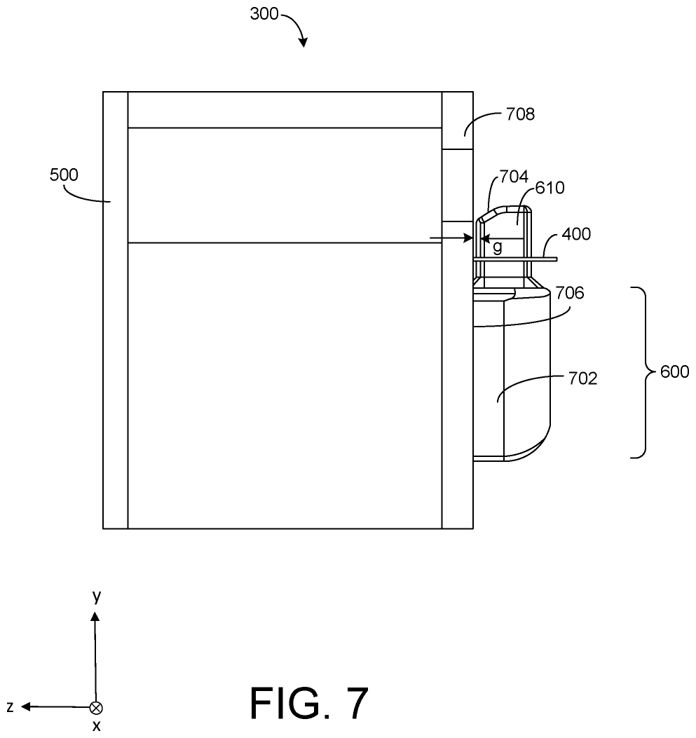

FIG. 7 is a magnified side elevation view showing the orientation of the flexure 300 relative to the shelf 600 and the alignment pin 610, according to a possible implementation of the present disclosure. In some implementations, one or both of the alignment pins 610 can have a second function to assist in guiding motion of the flexure 300. For example, the alignment pins 610 can have features that are designed to contact the flexure 300 and restrict its motion.

In some implementations, the shelf 600 can have a tapered edge 702, and the alignment pins 610 can have a flat profile with a top taper 704. The top taper 704 may serve as a guide for placement of the flexure 300 on the fixture 500. In some implementations, the shelf 600 may have a flat side 706 that can rest against a flat face 708 of the flexure 300, to hold the flexure 300 in place and prevent the flexure 300 from sliding in the −y-direction. The flexure 300 and the alignment pin 610 can be spaced apart by a small gap g. In some implementations, the size of the gap g can be in a range of about 0.08 mm to about 0.12 mm. In some implementations, the tapered edge 702 may serve to guide initial insertion of the flexure 300.

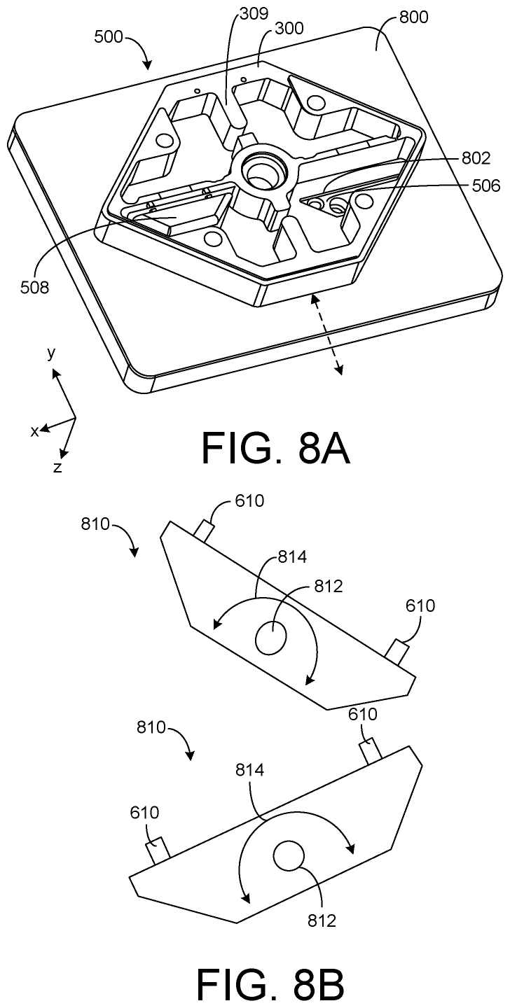

FIG. 8A is a perspective view of the flexure 300 installed on the fixture 500, according to a possible implementation of the present disclosure. FIG. 8A further illustrates the addition of a low friction cover 800. The low friction cover 800 can serve to facilitate sliding movement of the flexure 300 relative to the fixture 500, in a vertical direction shown by the dashed arrow, as permitted by the slots 510.

In some implementations, the low friction cover 800 can be disposed between the fixture 500 and the flexure 300, and can be adhered to the fixture 500 with an adhesive, e.g., epoxy, glue, etc. The low friction cover 800 can serve to prevent abrasion of the fixture 500 and/or the back side of the flexure 300. The low friction cover 800 can also prevent binding of the metals within the flexure 300 and the fixture 500. The low friction cover 800 can include cutouts 802 that permit access to the second set of holes 506 and the slots 510, which are behind the flexure 300. In some implementations, the low friction cover 800 can include a low friction material, e.g., a slippery material such as Teflon®, ceramic, glass, polished metal, etc. In some implementations, the low friction cover 800 can include a material characterized by a hardness lower than that of the flexure 300.

FIG. 8B is a side elevation view of a pivoting shelf assembly 810, according to a possible implementation of the present disclosure. The pivoting shelf assembly 810 is a variation of the shelf assembly 508 that can be substituted for the shelf assembly 508. Use of the pivoting shelf assembly 810 may result in a substantially even pressure being applied to both of the sensors 312 during assembly.

In some implementations, the pivoting shelf assembly 810 can be attached to the fixture 500 using a central mounting pin, e.g., a rocker pivot 812, instead of the mounting pins 602. The rocker pivot 812 permits the pivoting shelf assembly 810 to rotate around the center of mass of the pivoting shelf assembly 810, as shown by the arrows 814. The top of FIG. 8B shows clockwise rotation about the rocker pivot 812; the bottom of FIG. 8B shows counterclockwise rotation about the rocker pivot 812. Rotation of the pivoting shelf assembly 810 can compensate for differential pressure that may be applied to the sensors 312 during assembly.

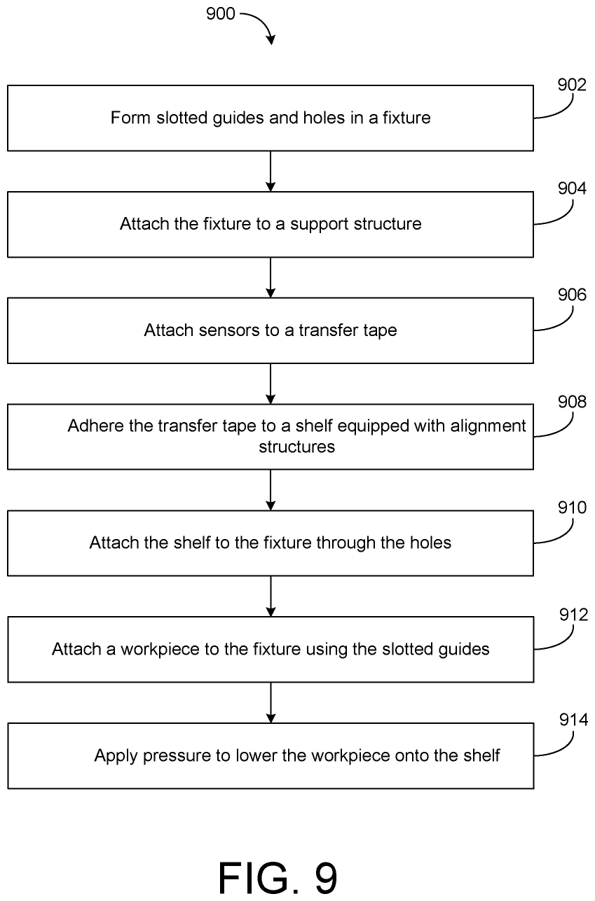

FIG. 9 illustrates a method 900 of assembling a workpiece equipped with micro-sensors, e.g., the flexure 300 equipped with the sensors 312, according to a possible implementation of the present disclosure. Operations of the method 900 can be performed in a different order, or not performed, depending on specific applications. The method 900 may be performed using the apparatus shown in FIGS. 3A, 3B, 4A, 4B, 5, 6, 7, 8A, 8B, 10, 11, 12A, 12B, 13, 14, 15, 16A, and 16B. The method 900 includes operations for mounting sensors onto the flexure 300 for installation on a display 102. It is noted that the method 900 may improve image quality on the display 102 but may not completely eliminate disturbances affecting camera positions of cameras mounted to the display 102. Accordingly, it is understood that additional processes can be provided before, during, or after the method 900, and that some of these additional processes may be briefly described herein.

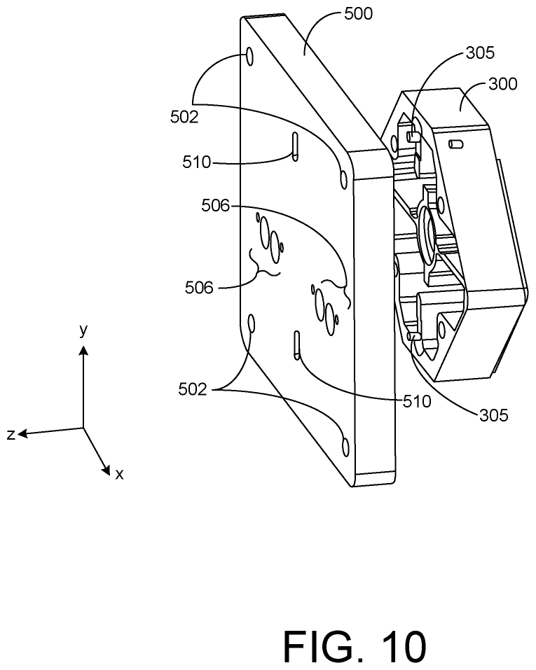

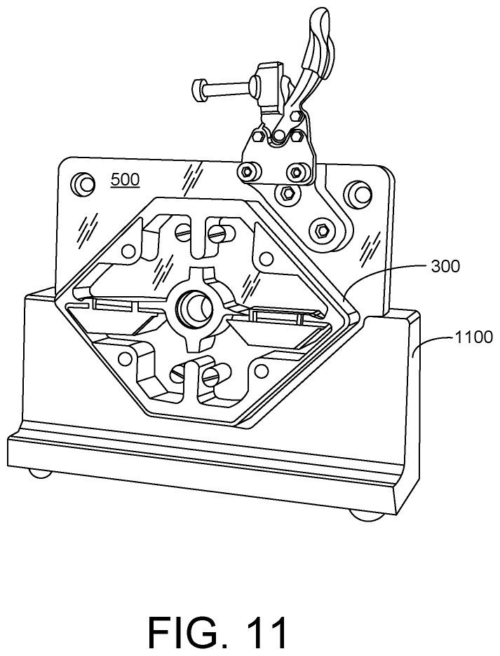

The method 900 includes, at 902, forming slotted guides and holes in a fixture, e.g., the fixture 500, according to a possible implementation of the present disclosure. With reference to FIG. 10, the corner holes 502, the second set of holes 506, and the slots 510 can be machined in a back side of the fixture 500. The mounting pins 305 can then be aligned within the slots 510 to allow some adjustment of the vertical position of the flexure 300 relative to the fixture 500 The method 900 includes, at 904, attaching the fixture 500 to a support structure 1100, according to a possible implementation of the present disclosure. The support structure 1100 can be, for example, a wall, a holder as shown in FIG. 11, or any other type of support structure that can hold the fixture 500 to allow joining the fixture 500 together with one or more sensors 312 in a controlled fashion.

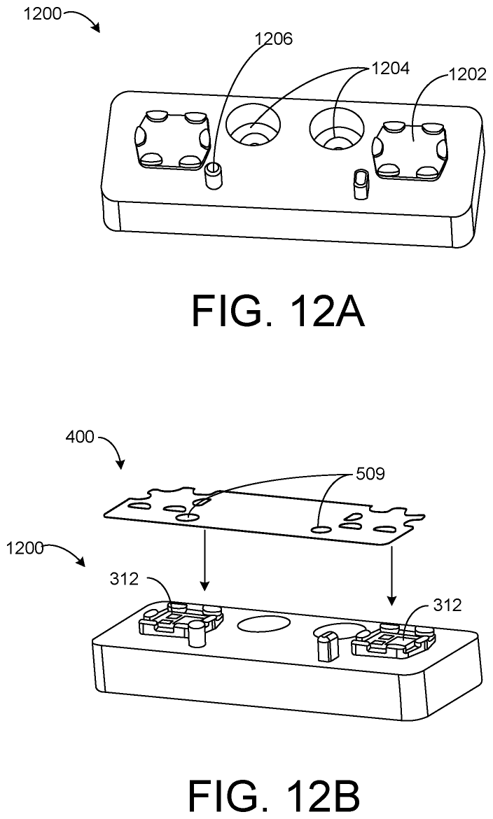

The method 900 includes, at 906, attaching sensors, e.g., strain gauges, to a transfer tape, e.g., the film 400, according to a possible implementation of the present disclosure. With reference to FIGS. 12A and 12B, a jig 1200 can be provided to align the sensors 312 to the film 400 and to place the sensors 312 onto the film 400. The jig 1200 can include sensor pads 1202, openings 1204, and alignment pins 1206. The openings 1204 can accept fasteners e.g., screws, pins, nails, etc. As shown in FIG. 12B, the sensors 312 can be placed on the sensor pads 1202 and then the mounting holes 509 in the film 400 can be aligned with the alignment pins 1206 so that the sensors 312 are properly mounted onto the film 400 as the film 400 is lowered onto the jig 1200.

The method 900 includes, at 908, attaching the transfer tape, e.g., the film 400, to a shelf, e.g., the shelf assembly 508, according to a possible implementation of the present disclosure. With reference to FIG. 12B, the film 400 can be lowered onto the shelf 600 using the alignment pins 610 as a guide. As the film 400 is lowered, the mounting holes 509 can be positioned directly over the alignment pins 610 to facilitate coupling with the alignment pins 610.

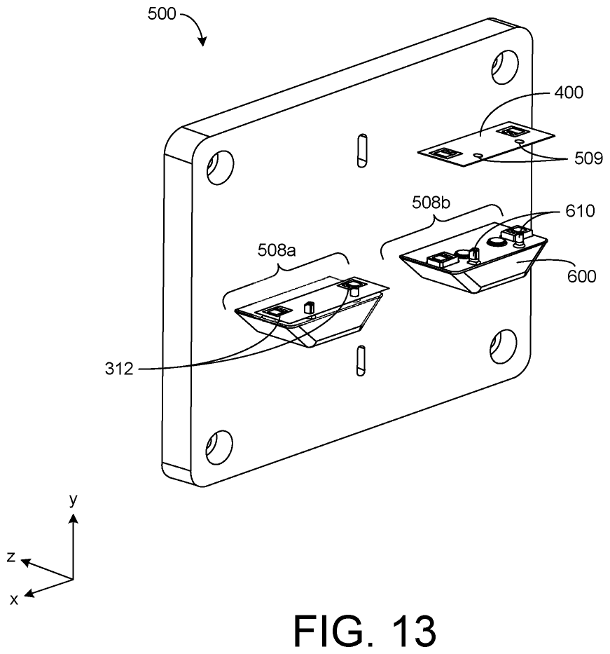

The method 900 includes, at 910, attaching the shelf assembly 508 to the fixture 500 through the holes, e.g., the second set of holes 506, according to a possible implementation of the present disclosure. With reference to FIG. 13, the shelf assembly 508a is shown with the sensors 312 already attached, while the shelf assembly 508b is shown during the attachment process, as the mounting holes 509 of the film 400 are being lowered onto the alignment pins 610. Following placement of the film 400 on the shelf 600, an adhesive can be applied to exposed top sides of the sensors 312.

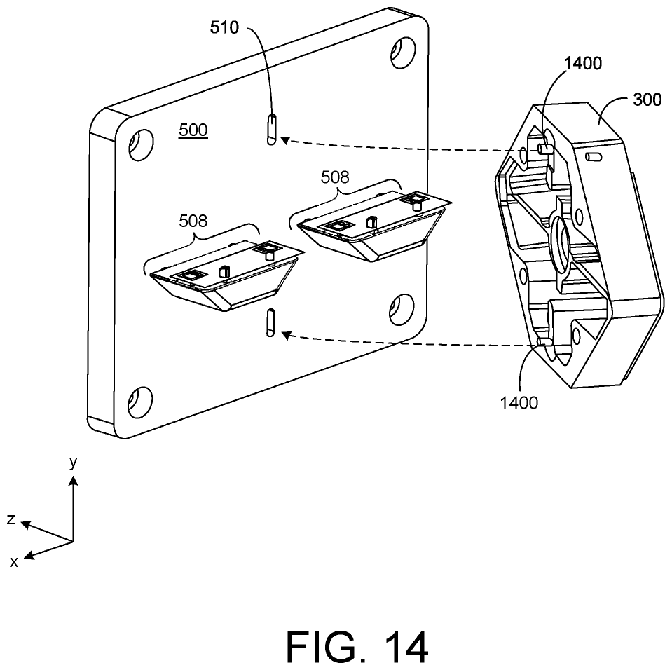

The method 900 includes, at 912, attaching a workpiece, e.g., the flexure 300, to the fixture 500 using the slotted guides, e.g., the slots 510, according to a possible implementation of the present disclosure. With reference to FIG. 14, the flexure 300 can be attached to the fixture 500 after the shelf assemblies 508 are already in place. The mounting pins 305 on a back side of the flexure 300 can then be inserted into the slots 510 in the fixture 500 as indicated by the dashed arrows. The flexure 300 can be pre-cleaned before attachment to the fixture 500.

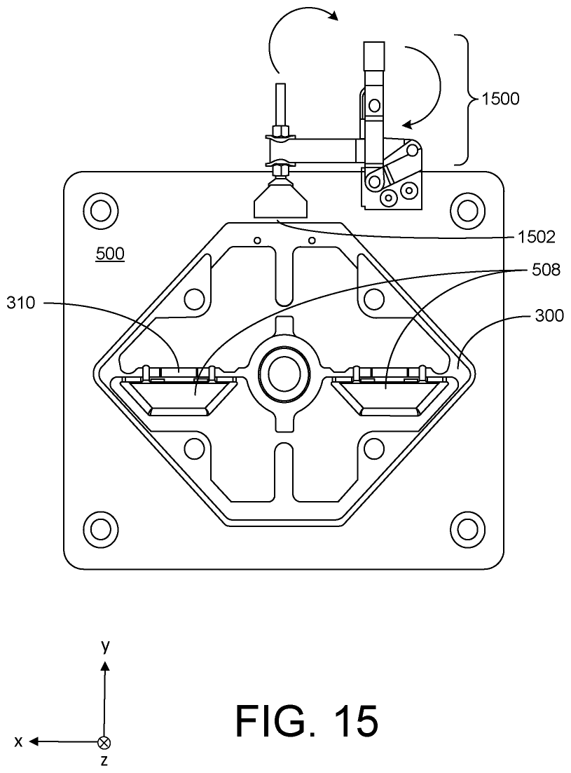

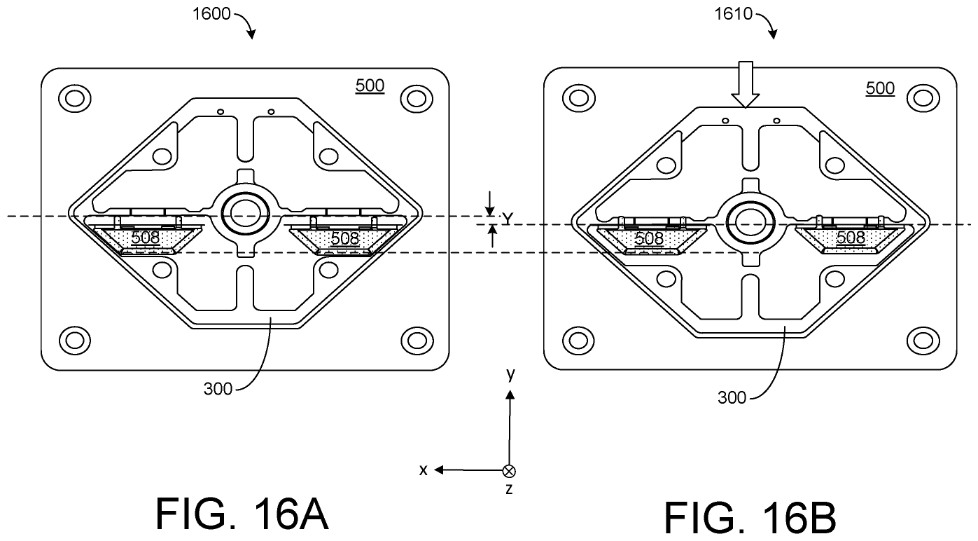

The method 900 includes, at 914, applying a force to lower the workpiece, e.g., the flexure 300, onto the shelf assemblies 508, according to a possible implementation of the present disclosure. The applied force can be a constant, or continuous force. With reference to FIG. 15, FIG. 16A, and FIG. 16B, a press 1500 can be engaged, e.g., by hand or automatically by a robot, to apply pressure to the flexure 300. In some implementations, the press 1500 can be in the form of a toggle clamp that attaches to the fixture 500. Once the flexure 300 and the shelf assemblies 508 are in position on the fixture 500, the press 1500 can be rotated, e.g., counterclockwise, from a resting position as shown in FIG. 11 to an active position as shown in FIG. 15. An arm of the press 1500 can then exert pressure on a top surface 1502 of the flexure 300, thereby sliding the flexure 300 downward in the-y direction to bring together the crossbar 310 with the shelf assemblies 508 bearing the sensors 312, In some implementations, lowering the flexure 300 onto the shelf assemblies 508 proceeds until the hard stops 606 are encountered. In some implementations, the press 1500 can include a compliant contact located where the press 1500 meets the top surface 1502. In some implementations, the press 1500 can continue to apply pressure throughout a time interval for curing the adhesive. During the curing time interval, if a heat sensitive adhesive is used, heaters on the shelf 600 may be activated while the press is engaged. The press 1500 can be held in place on the surface 1502 by a force, e.g., via one or more screws, springs, magnets, weights, or a center pin.

With reference to FIGS. 16A and 16B, the flexure 300 is shown in an initial, upper position 1600 in FIG. 16A, and in a final, lower position 1610 in FIG. 16B, after traveling a vertical distance Y relative to the fixture 500. When the flexure 300 is in the upper position 1600, the shelf assembly 508 is spaced apart from the crossbar 310. When the flexure 300 is in the lower position 1610, the sensors 312 are in contact with the crossbar 310. After an adhesive curing time interval, the pressure can be released so that the flexure 300 moves apart from the 508, leaving the film 400 with the sensors 312 on the underside of the crossbar 310. The flexure 300 can then be removed from the fixture 500 and the film 400 can be peeled away from the sensors 312.

As described above, a system and method for attaching sensors, e.g., micro-sensors, to a workpiece can result in reliable precision placement of the sensors. In one example, an intermediate fixture can be used to align strain gauges to a flexure device that can be installed on a back plate of a display 102. The flexure device can maintain planarity of the display 102 by compensating for stresses on the back plate, in response to strain measurements made by the sensors. During assembly, the fixture, in conjunction with various alignment pins, can constrain motion of the flexure device and the strain gauges permitting the two parts to be joined in a precise manner. Such a system can be generalized for use with other examples in which workpieces are assembled together with micro-sensors.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below”, or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second”element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A device, comprising:
a fixture;
a shelf configured for fixed attachment to the fixture, the shelf equipped with alignment structures;
a film configured to couple to the alignment structures; and
a workpiece configured for attachment to the fixture and translational motion in a single direction.

2. The device of claim 1, wherein the fixture is formed with holes for receiving fasteners of the shelf.

3. The device of claim 1, wherein the fixture is formed with slots for receiving fasteners of the workpiece.

4. The device of claim 1, wherein the alignment structures include compliant elements.

5. The device of claim 4, wherein the compliant elements include a compressible material.

6. The device of claim 1, wherein the alignment structures include vertical pins.

7. The device of claim 1, wherein the workpiece is a flexure device.

8. The device of claim 1, wherein the film serves as a vehicle for a sensor.

9. The device of claim 8, wherein the sensor is a micro-mechanical strain gauge.

10. The device of claim 1, wherein the film includes round openings.

11. A system, comprising:
a micro-sensor;
a workpiece configured to receive the micro-sensor; and
a fixture configured to hold the micro-sensor and the workpiece while guiding alignment of the micro-sensor to the workpiece.

12. The system of claim 11, wherein the micro-sensor is attached to a film having alignment holes.

13. The system of claim 12, further comprising a shelf configured to receive the film, the shelf having alignment structures.

14. The system of claim 13, wherein the shelf is configured for attachment to the fixture by a rocker pivot.

15. The system of claim 11, wherein the micro-sensor is a strain gauge.

16. The system of claim 11, wherein the workpiece is a flexure device.

17. The system of claim 11, wherein the fixture is equipped with a low friction cover.

18. A method, comprising:
forming slotted guides and holes in a fixture;
attaching the fixture to a support structure;
attaching gauges to a transfer tape;
adhering the transfer tape to a shelf equipped with alignment structures;
attaching the shelf to the fixture through the holes;
attaching a workpiece to the fixture through the slotted guides; and
lowering the workpiece onto the shelf.

19. The method of claim 18, wherein lowering the workpiece applies a constant force to the shelf.

20. The method of claim 18, wherein lowering the workpiece proceeds until a hard stop is encountered.
